(19) United States
(12) Patent Application Publication
(10) Pub. No.: US 2026/0084944 A1
(43) Pub. Date: Mar. 26, 2026

(54) MANEUVERING JACK

(71) Applicant: Robert Bosch GmbH, Stuttgart (DE)

(72) Inventor: Uwe Riedel, Waldbronn (DE)

(21) Appl. No.: 19/113,594

(22) PCT Filed: Oct. 18, 2023
(86) PCT No.: PCT/EP2023/078939

§ 371 Date: Mar. 20, 2025

(30) Foreign Application Priority Data
Oct. 28, 2022 (DE) 10 2022 211 486.8

(51) Int. Cl. B66F 7/24; B60S 13/00; B66F 7/28

(52) U.S. Cl. CPC B66F 7/246; B60S 13/00; B66F 7/28

(57) ABSTRACT

A maneuvering jack for holding a wheel of a vehicle, in particular a motor vehicle. The maneuvering jack includes a base carrier, which comprises rolling elements in order to support the base carrier movably on an underlying surface; a lifting element, which is arranged on the base carrier and is provided for holding a wheel; at least one lifting device, which is designed to vary the height of the lifting element in relation to the base carrier; and at least one drive device, which is designed to drive at least one of the rolling elements in order to move the maneuvering jack on the underlying surface.

### FIELD

The present invention relates to a maneuvering jack for holding and raising a wheel of a vehicle, in particular a motor vehicle, in the repair shop area. The present invention also relates to a method for transporting a motor vehicle with maneuvering jacks according to the present invention.

### BACKGROUND INFORMATION

Mechanical maneuvering aids that make it possible to move motor vehicles in the repair shop area manually, i.e., with muscular power, are available. Such maneuvering aids may be designed with manually actuated hydraulic lifting devices, which make it possible to raise a vehicle arranged on the maneuvering aid a few centimeters so that the wheels of the motor vehicle lose contact with the underlying surface and the motor vehicle can be moved across the underlying surface as desired.

### SUMMARY

An object of the present invention is to provide a maneuvering aid for motor vehicles that simplifies moving motor vehicles on an underlying surface.

A maneuvering jack according to an example embodiment of the present invention for holding a wheel of a vehicle, in particular of a motor vehicle, has a base carrier with rolling elements, which support the base carrier movably on an underlying surface; a lifting element, which is arranged on the base carrier and is provided for holding a wheel; and at least one lifting device, which is designed to move the lifting element selectively upward and downward in order to vary the height of the lifting element in relation to the base carrier.

A maneuvering jack according to an example embodiment of the present invention also has at least one drive device, which is designed to drive at least one of the rolling elements in order to move the maneuvering jack on the underlying surface.

The drive device of a maneuvering jack according to the present invention simplifies moving the maneuvering jack on the underlying surface. Motor vehicles can therefore be maneuvered easily and conveniently across the underlying surface by means of a maneuvering jack according to the present invention.

In one example embodiment of the present invention, the rolling elements are formed as balls, each of which is rotatable about an axis aligned arbitrarily in space. As a result, the maneuvering jack is movable in any direction across the underlying surface and is also rotatable in place.

In one example embodiment of the present invention, the drive device comprises a first drive mechanism and a second drive mechanism. The first drive mechanism is designed to rotate the ball about a first axis, and the second drive mechanism is designed to rotate the ball about a second axis. The second axis is aligned transversely, in particular orthogonally, to the first axis.

Each drive mechanism may each comprise a friction element, for example a friction disk, which is designed to drive the ball by friction between the ball and the friction element when the friction element is rotated. Such a drive device makes it possible to rotate the ball purposefully about an axis that is aligned arbitrarily in space. In particular, the alignment of the rotation axis of the ball in space can be changed by varying the rotational speeds of the two friction elements.

In one example embodiment of the present invention, the lifting element is designed to support the wheel of the motor vehicle such that the wheel is rotatable about its rotational axis. In particular, the lifting element may comprise rollers that support the wheel of the motor vehicle such that the wheel is rotatable about its rotational axis. A lifting element designed in this way makes it possible to rotate a wheel supported on the lifting element about its rotational axis for diagnostics and/or for setting vehicle parameters.

In one example embodiment of the present invention, the maneuvering jack comprises at least one tire sensor, which is designed to sense a state of a wheel supported on the lifting element.

Such a tire sensor may, for example, be an optical tire sensor that makes it possible to check a wheel arranged on the lifting element optically for damages and/or to recognize and check the tire tread depth and/or the wear profile of the wheel/tire. An optical tire sensor may be designed as a 2D camera or a 3D camera.

An optical tire sensor may be designed to detect light in the visible range, infrared light, and/or UV light.

The tire sensor may also comprise a lighting device with a light source, which is designed to illuminate the areas of the wheel that are sensed by the optical tire sensor, with light, in particular with light in the visible range, with infrared light, and/or with UV light, in order to improve the quality of the measurement results provided by the tire sensor.

A tire sensor provided on the maneuvering jack may also be designed as an air pressure sensor, which makes it possible to read out an existing tire pressure control sensor in the wheel, for example via wireless Bluetooth or NFC communication, in order to check the air pressure in the tire of the wheel.

In one example embodiment of the present invention, the maneuvering jack comprises at least one width adjustment element, which makes it possible to change the width of the maneuvering jack. For example, the width adjustment element may be designed as a telescopic element that has a variable dimension.

By means of a width adjustment element, the maneuvering jack can be adapted to tires that have different dimensions. As a result, the maneuvering jack can be used in conjunction with a variety of different tire types and sizes.

In one example embodiment of the present invention, the maneuvering jack is designed with a receptacle or coupling that makes it possible to couple the maneuvering jack to an external device, e.g., to a lifting device/platform, in order to raise the maneuvering jack and a motor vehicle arranged on the maneuvering jack.

In one example embodiment of the present invention, the maneuvering jack comprises a control device, which is designed to control the at least one drive device in order to move the maneuvering jack across the underlying surface.

By means of such a control device, the maneuvering jack can be moved across the underlying surface of a repair shop in an automated manner. As a result, the maneuvering of motor vehicles by means of maneuvering jacks according to the present invention can be simplified even further. In particular, the movements of multiple maneuvering jacks arranged underneath the wheels of a motor vehicle can be coordinated with one another in order to maneuver the motor vehicle across the underlying surface of the repair shop by jointly moving the maneuvering jacks.

In one example embodiment of the present invention, the maneuvering jack comprises a navigation device, which makes it possible to determine the current position of the maneuvering jack on the underlying surface. In particular, the navigation device may be designed to determine the current position of the maneuvering jack at a workstation and/or storage location. This makes it possible to automate the movements of the maneuvering jack. The use of the maneuvering jack can thus be simplified even further.

In one example embodiment of the present invention, the maneuvering jack comprises a communication device, which is designed to communicate with the communication device of at least one other maneuvering jack and/or with the communication device of an external controller. In particular, the communication may be carried out wirelessly, for example via WLAN, Bluetooth®, a mobile radio network, satellite-based communication network, or by means of infrared light. A SIM card may be provided in the communication device for communication via a mobile radio network.

By means of a communication device, the maneuvering jack can be controlled from the outside. A communication device also makes it possible for multiple maneuvering jacks to communicate with one another in order to coordinate their movements. In particular, the movements of multiple maneuvering jacks can be coordinated such that the maneuvering jacks together hold all wheels of a motor vehicle and transport the motor vehicle to a specified position in coordinated movements.

The present invention also comprises a set of multiple maneuvering jacks according to the present invention, in particular a set of four maneuvering jacks, wherein the maneuvering jacks of the set of maneuvering jacks are designed to communicate with one another in order to coordinate their movements.

The present invention also comprises a usage area, e.g., a repair shop, workstation, and/or storage location, or a larger site, e.g., company premises, with an underlying surface and a communication device, which is designed to communicate with at least one maneuvering jack according to the present invention. In particular, the communication device may be designed for wireless communication, for example via WLAN, Bluetooth®, a mobile radio network, satellite-based network for communication and/or position determination, and/or infrared light. A SIM card may be provided in the communication device for communication via a mobile radio network.

In the usage area of the maneuvering jack, according to an example embodiment of the present invention, position sensors may additionally be provided, for example optical position sensors, which make it possible for the current position of the at least one maneuvering jack in the usage area to be determined and communicated to a control device. The control device may be provided on at least one of the maneuvering jacks or as an external controller.

The present invention also comprises a method for transporting a motor vehicle by means of a set of maneuvering jacks according to the present invention. In particular, the method comprises controlling the maneuvering jacks such that each maneuvering jack drives to one of the wheels of the motor vehicle, holds and raises the corresponding wheel of the motor vehicle, and the maneuvering jacks transport the raised vehicle to a specified destination in a coordinated manner.

In a use case described by way of example, a motor vehicle is parked by a driver in a previously defined parking zone.

A camera-based monitoring system of the parking zone recognizes that the motor vehicle has been parked there, and sends a command to retrieve the motor vehicle to four maneuvering jacks designed according to the present invention.

The maneuvering jacks then drive autonomously to the parked motor vehicle, recognize the corresponding wheel or their place of use on the motor vehicle, and raise it by means of their lifting elements and lifting devices. Subsequently, the maneuvering jacks transport the vehicle through coordinated movements to a specified location where the vehicle can be stored and/or where further services can be performed on the vehicle.

These services may include, for example, charging the battery of the motor vehicle, performing a vehicle wash, recognizing damages to the exterior of the vehicle, e.g., by means of a camera-based image recognition system, and/or transporting the motor vehicle into the repair area in a repair shop, or temporarily storing it before and after performing the aforementioned services.

An embodiment example of a maneuvering jack according to the present invention is described below with reference to the accompanying figures.

### BRIEF DESCRIPTION OF THE DRAWINGS

FIG. 1 shows a schematic plan view of a usage area with a motor vehicle and four maneuvering jacks, according to an example embodiment of the present invention.

FIG. 2 shows a schematic plan view of a maneuvering jack according to an example embodiment of the present invention.

FIG. 3 shows a schematic side view of a maneuvering jack according to an example embodiment of the present invention.

FIG. 4 shows a schematic rear view of a maneuvering jack according to an example embodiment of the present invention.

FIG. 5 shows a schematic view of a drive device for driving a maneuvering jack according to an example embodiment of the present invention.

### DETAILED DESCRIPTION OF EXAMPLE EMBODIMENTS

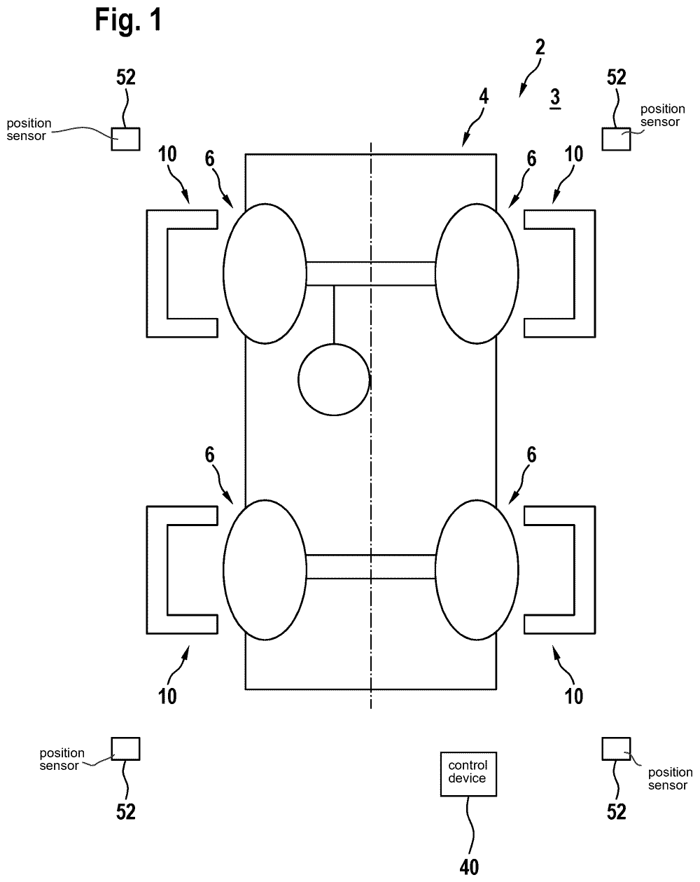

FIG. 1 shows a schematic plan view of a usage area 2 with a motor vehicle 4 with four wheels 6 and four maneuvering jacks 10, which are arranged next to the four wheels 6 of the motor vehicle 4. The usage area 2 may, for example, be a repair shop space, a workstation, or a storage location for motor vehicles 5. The usage area 2 may also be a larger site, which may in particular comprise multiple repair shop spaces, workstations, and/or storage locations.

Maneuvering jacks 10 are technical devices designed to grip and raise one wheel 6 each of the motor vehicle 4. By means of four maneuvering jacks 10, the motor vehicle 4 can be raised completely from the underlying surface 3 of the usage area 2 and subsequently moved freely in the usage area 2.

In the usage area, position sensors 52, for example optical position sensors 52, may additionally be provided, which make it possible for the current positions of the maneuvering jacks 10 to be recognized and communicated to a control device 40.

Alternatively or additionally, the current positions of the maneuvering jacks 10 may be determined via GPS sensors and/or optical sensors, e.g., cameras, installed in the maneuvering jacks 10.

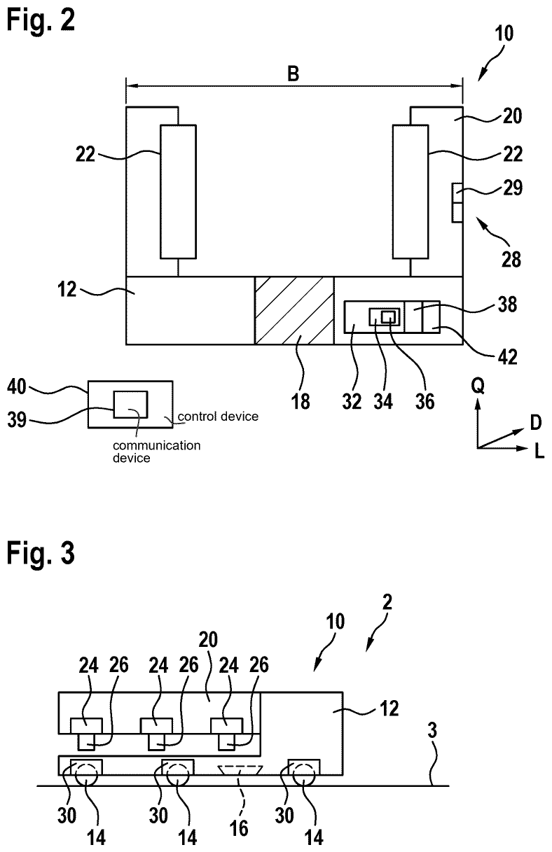

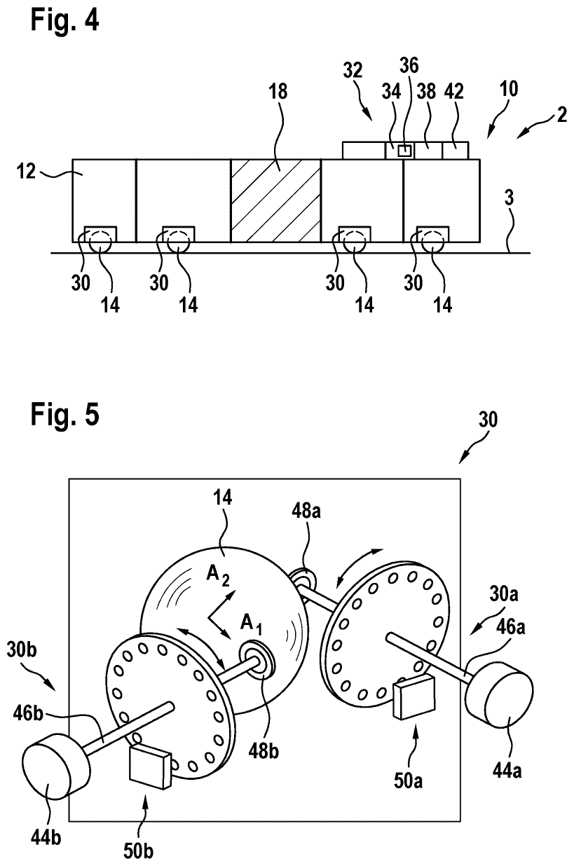

FIG. 2 shows a schematic plan view of a maneuvering jack 10 designed according to an embodiment example of the present invention. FIG. 3 shows a schematic side view, and FIG. 4 shows a schematic rear view of the maneuvering jack 10 shown in FIG. 2.

The maneuvering jack 10 has a base carrier 12, which is equipped with multiple rolling elements 14, which support the base carrier 12 movably on the underlying surface 3 of the usage area 2.

The rolling elements 14 may in particular be balls 14, which make it possible to move the maneuvering jack 10 on the underlying surface 3 in all directions, i.e., in a longitudinal direction L, in a transverse direction Q, and in any diagonal directions D. Rolling elements 14 designed as balls 14 also make it possible to rotate the maneuvering jack 10 in place.

The maneuvering jack 10 can be designed with a receptacle or coupling 16, which makes it possible to couple the maneuvering jack 10, for example, to a lifting platform (not shown) in order to raise the maneuvering jack 10 and a motor vehicle 4 arranged on the maneuvering jack 10.

The maneuvering jack 10 may also be equipped with at least one width adjustment element 18, which makes it possible to change the width B of the maneuvering jack 10. This makes it possible to adapt the maneuvering jack 10 to differently sized wheels 6 of the motor vehicle 4. For example, the width adjustment element 18 may be designed to be telescopic.

The maneuvering jack 10 has a lifting element 20, which is arranged on or at the base carrier 12 and is provided for holding a wheel 6 of the motor vehicle 4.

Rollers 22 are present on the lifting element 20 and make it possible for a wheel 6 arranged on the lifting element 20 to rotate about its axis.

The maneuvering jack 10 also has at least one lifting device 24, which makes it possible to vary the height of the lifting element 20 in relation to the base carrier 12 in order selectively to raise and lower a wheel 6 arranged on the lifting element 20, and thus also the motor vehicle 4 to which the wheel 6 is attached.

In the embodiment example shown, the lifting device 24 comprises multiple lifting cylinders 26, which are hydraulically retractable and extendable in order to vary the height of the lifting element 20 in relation to the base carrier 12.

Other mechanisms for driving the lifting element 20, e.g., rack and pinion drives and worm drives, may also be provided instead of lifting cylinders 26.

One or more wheel sensors 28 may be provided on the lifting element 20, which make it possible to check the state of a wheel 6 arranged on the lifting element.

For example, the wheel sensors 28 may include optical wheel sensors 28 (cameras), which make it possible to check the wheel 6 checked for damages and/or to recognize the tire tread depth or the wear profile of the tire of the wheel 6. The optical wheel sensors 28 may be designed to detect light in the visible range, infrared light, and/or UV light. The wheel sensors 28 may also comprise one or more lighting devices 29, which are designed to illuminate the areas of the wheel 6 that are sensed by the optical wheel sensors 28, with light in the visible range, with infrared light, and/or with UV light.

Wheel sensors 28 that make it possible to read out an existing tire pressure control sensor in the wheel 6, e.g., via Bluetooth or NFC communication, in order to determine the air pressure in the tire of the wheel 6 may also be provided.

Drive devices 30 are provided on the rolling elements 14, which drive devices are designed to drive the corresponding rolling element 14 in order to move the maneuvering jack 10 on the underlying surface 3.

A drive device 30 may be provided on each of the rolling elements 14.

In alternative embodiment examples, one drive device 30 each may be provided only on selected rolling elements 14 in order to reduce the costs of the maneuvering jack 10.

The maneuvering jack 10 also has a control device 32, which is designed to control the drive device(s) 30 in order to move the maneuvering jack 10 across the underlying surface 3 in a controlled manner.

The control device 32 in particular comprises a navigation device 34, which makes it possible to determine the current position of the maneuvering jack 10 on the underlying surface 3.

The navigation device 34 may comprise one or more environmental sensors 36 in order to sense the environment of the maneuvering jack 10 and thus to determine the current position of the maneuvering jack 10 on the underlying surface 3, for example in relation to a motor vehicle 4.

The maneuvering jack 10 also comprises a communication device 38, which is designed to communicate with a corresponding communication device 38 of at least one other maneuvering jack 10 and/or with a communication device 39 of an external controller 40. This makes it possible to control the movement of the maneuvering jack 10 by means of the external controller 40. In particular, it makes it possible to coordinate the activities of multiple maneuvering jacks 10 located in the usage area 2.

The communication devices 38, 39 may in particular be designed for wireless communication, for example, by means of WLAN, Bluetooth®, infrared light, or similar technology, so that cable connections, which could restrict and impede the movement of the maneuvering jack 10, can be dispensed with.

The communication devices 38, 39 may also be designed to transmit data sensed by the wheel sensors 28 to the external controller 40 or to another external receiving device in order to make it possible externally to examine, evaluate, and, where necessary, log the measurement results of the wheel sensors 28.

The maneuvering jack 10 also has an electrical energy source 42, in particular a rechargeable electrical battery (accumulator), in order to supply electrical energy to the lifting device 24, the wheel sensors 28, the drive device 30, the control device 32, the navigation device 34, and the communication device 38. A maneuvering jack 10 equipped with an electrical energy source 4 can be operated without an electrical cable connection to an external energy source.

For example, the electrical energy source 42 may be charged via a detachable cable connection or wirelessly via an inductive charging system.

FIG. 5 shows a schematic illustration of an embodiment example for a drive device 30 for driving a rolling element 14, which is designed as a ball 14.

The drive device 30 comprises a first drive mechanism 30a, which is designed to rotate a ball 14 about a first axis A₁, and a second drive mechanism 30b, which is designed to rotate the ball 14 about a second axis A₂. The second axis A₂ is aligned transversely, in particular orthogonally, to the first axis A₁.

In the embodiment example shown in FIG. 5, the two drive mechanisms 30a, 30b are identical in design. Each of the two drive mechanisms 30a, 30b has a corresponding electric drive motor 44a, 44b, which is connected in each case to a friction element 48a, 48b, in particular a friction disk 48a, 48b, via a drive axis 46a, 46b so that the friction element 48a, 48b is rotatable by operating the drive motor 44a, 44b.

An outer peripheral surface of each of the two friction elements 48a, 48b is in contact with the surface of the ball 14. The outer peripheral surfaces of the two friction elements 48a, 48b and the surface of the ball 14 are designed such that the ball 14 is rotated due to the friction between the outer peripheral surface of one of the two friction elements 48a, 48b and the surface of the ball 14 when the corresponding friction element 48a, 48b rotates about its axis A₁, A₂.

By controlling the two drive motors 44a, 44b purposefully so that the two friction elements 48a, 48b rotate at the same rotational speed or at different rotational speeds, it is possible to cause the ball 14 to rotate about a ball rotational axis that can be oriented arbitrarily in space. In particular, the spatial alignment of the ball rotational axis can be varied by changing the rotational speeds of the two friction elements 48a, 48b.

Rotation sensors 50a, 50b may be provided on the drive axles 46a, 46b, which rotation sensors make it possible to detect the rotation of the corresponding drive axle 46a, 46b and of the friction elements 48a, 48b attached to the drive axles 46a, 46b, in order to be able to control the two drive motors 44a, 44b accordingly.

The embodiment example of a drive mechanism 30 shown in FIG. 5 for driving a spherical rolling element 14 is only shown by way of example. Other rolling elements 14 and drive mechanisms 30 may also be used instead of the drive mechanism 30 shown in FIG. 5. For example, pivotable wheels and/or rollers that are connected to the corresponding drive mechanism 30 may be provided as rolling elements 14.

The use of automated maneuvering jack 10 according to the present invention makes it possible to reduce the human effort when transporting motor vehicles 4. Automated maneuvering jacks 10 make an automated process of performing services on a motor vehicle possible. The high flexibility of the spatial mobility of the motor vehicle when using maneuvering jacks according to the present invention allows a changed spatial concept, which requires less space for performing services on motor vehicles and makes a more efficient arrangement of the technical equipment and machines required in a repair shop possible.

As a result, the service in automotive repair shops can be simplified and improved.

1-12. (canceled)

13. A maneuvering jack for holding a wheel of a motor vehicle, the maneuvering jack comprising:
a base carrier which includes rolling elements to support the base carrier movably on an underlying surface;
a lifting element arranged on the base carrier and configured to hold the wheel;
at least one lifting device configured to vary a height of the lifting element in relation to the base carrier; and
at least one drive device configured to drive at least one of the rolling elements to move the maneuvering jack on the underlying surface.

14. The maneuvering jack according to claim 13, wherein the rolling elements are balls, and the at least one drive device includes a first drive mechanism configured to rotate a ball about a first axis, and a second drive mechanism configured to rotate a ball about a second axis.

15. The maneuvering jack according to claim 14, wherein the first and second drive mechanisms include a friction disk configured to drive the ball by friction.

16. The maneuvering jack according to claim 13, wherein the lifting element is configured to rotatably support the wheel of the motor vehicle, wherein the lifting element includes rollers to support the wheel of the motor vehicle.

17. The maneuvering jack according to claim 13, wherein the maneuvering jack includes at least one wheel sensor configured to sense a state of a wheel supported on the lifting element.

18. The maneuvering jack according to claim 13, wherein the maneuvering jack includes at least one width adjustment element, which makes it possible to change a width of the maneuvering jack.

19. The maneuvering jack according to claim 13, wherein the maneuvering jack includes a control device configured to control the at least one drive device to move the maneuvering jack on the underlying surface.

20. The maneuvering jack according to claim 19, wherein the control device includes a navigation device, which makes it possible to determine a position of the maneuvering jack on the underlying surface.

21. The maneuvering jack according to claim 13, wherein the maneuvering jack includes a communication device configured to communicate wirelessly with another maneuvering jack and/or with an external controller.

22. A set of four maneuvering jacks, each of the maneuvering jacks comprising:
a base carrier which includes rolling elements to support the base carrier movably on an underlying surface;
a lifting element arranged on the base carrier and configured to hold a wheel of a motor vehicle;
at least one lifting device configured to vary a height of the lifting element in relation to the base carrier; and
at least one drive device configured to drive at least one of the rolling elements to move the maneuvering jack on the underlying surface;
wherein the maneuvering jacks are configured to communicate with one another.

23. A usage area comprising:
an underlying surface; and
a communication device configured to communicate with at least one maneuvering jack, each of the at least one maneuvering jacks configured to hold a wheel of a motor vehicle, the maneuvering jack including:
a base carrier which includes rolling elements to support the base carrier movably on an underlying surface,
a lifting element arranged on the base carrier and configured to hold the wheel,
at least one lifting device configured to vary a height of the lifting element in relation to the base carrier,
at least one drive device configured to drive at least one of the rolling elements to move the maneuvering jack on the underlying surface, and
a communication device configured to communicate wirelessly with another maneuvering jack and/or with an external controller;
wherein the usage area includes position sensors which make it possible to determine a position of the at least one maneuvering jack.

24. A method for transporting a motor vehicle using a set of maneuvering jacks, each of the maneuvering jacks including:
a base carrier which includes rolling elements to support the base carrier movably on an underlying surface,
a lifting element arranged on the base carrier and configured to hold a wheel of a motor vehicle,
at least one lifting device configured to vary a height of the lifting element in relation to the base carrier, and
at least one drive device configured to drive at least one of the rolling elements to move the maneuvering jack on the underlying surface,
wherein the maneuvering jacks are configured to communicate with one another;
the method comprising the following steps:
controlling the maneuvering jacks such that each of the maneuvering jacks drives to a wheel of the motor vehicle, holds and raises the wheel of the motor vehicle, and the maneuvering jacks transport the raised vehicle to a specified destination in a coordinated manner.
